(19) United States
(12) Patent Application Publication
(10) Pub. No.: US 2024/0109484 A1
(43) Pub. Date: Apr. 4, 2024

(54) LIGHTING DEVICE

(71) Applicant: TOYODA GOSEI CO., LTD., Kiyosu-shi (JP)

(72) Inventors: Toshiaki MORI, Kiyosu-shi (JP); Yoichi MATSUOKA, Kiyosu-shi (JP); Takao OKUMURA, Kiyosu-shi (JP); Koichiro ENDO, Nagoya-shi (JP)

(21) Appl. No.: 18/449,839

(22) Filed: Aug. 15, 2023

(30) Foreign Application Priority Data
Sep. 29, 2022 (JP) 2022-156750

(51) Int. Cl. B60Q 3/64; B60Q 3/12

(52) U.S. Cl. CPC B60Q 3/64; B60Q 3/12

(57) ABSTRACT

A lighting device includes a light source portion, a light guide that includes a light guide body with an elongated shape, guides light incident from the light source portion in a longitudinal direction of the elongated shape, and emits the light in an emission direction substantially orthogonal to the longitudinal direction, and a bezel that is provided along the light guide and includes an elongated-shaped opening through which the light emitted from the light guide passes and is emitted to the outside. The bezel includes at least one bridge portion that is formed along a lateral direction of the opening so as to partially bridge opposed walls of the opening in the lateral direction.

### CROSS-REFERENCE TO RELATED APPLICATIONS

The present patent application claims the priority of Japanese patent application No. 2022/156750 filed on Sep. 29, 2022, and the entire contents of Japanese patent application No. 2022/156750 are hereby incorporated by reference.

### TECHNICAL FIELD

The present invention relates to a lighting device.

### BACKGROUND ART

An elongated-shaped lighting device is known which is to be installed on, e.g., an instrument panel, etc., in the interior of a vehicle (see, e.g., Patent Literature 1). A cover panel of this lighting device includes a panel main body fixed on an instrument panel in the interior of a vehicle, and a lighting unit provided inside the panel main body. The panel main body is attached to the instrument panel. The panel main body has an opening that forms a gap between itself and the instrument panel, and light of the lighting unit is emitted from this opening to the interior of the vehicle.

Also, another elongated-shaped lighting device is known which is to be installed on, e.g., an instrument panel, etc., in the interior of a vehicle (see, e.g., Patent Literature 2). This lighting device is a vehicle interior lighting device which includes a lighting member having light-guiding properties and arranged on an instrument panel in the front part of a vehicle, and a substantially transparent clear cover body placed on the instrument panel at a portion in the vicinity of the lighting member. In the lighting device, the lighting member is housed in a groove extending in a vehicle width direction, and the groove housing the lighting member has an opening facing toward a lower surface. This opening is closed with the cover body (the clear cover body) as a substantially transparent clear member, and illumination light from the lighting member is emitted from the opening.

### CITATION LIST

### Patent Literatures

Patent Literature 1: JP 2009/184421 A
Patent Literature 2: JP 2006/103373 A

### SUMMARY OF INVENTION

The lighting device of Patent Literature 1 may cause a problem that the opening with an elongated shape has a small rigidity in the lateral direction of the elongated shape relative to the longitudinal direction and the shape of the opening cannot be maintained.

Also, the lighting device of Patent Literature 2 may cause a problem that the substantially transparent clear cover body, which is a separate member, needs to be placed to cover the elongated-shaped opening, which increases the number of parts and man-hours for assembly.

It is an object of the invention to provide a lighting device that can maintain the shape of an elongated-shaped opening.

(1) According to an aspect of the invention, a lighting device comprises:
a light source portion;
a light guide that comprises a light guide body with an elongated shape, guides light incident from the light source portion in a longitudinal direction of the elongated shape, and emits the light in an emission direction substantially orthogonal to the longitudinal direction; and
a bezel that is provided along the light guide and comprises an elongated-shaped opening through which the light emitted from the light guide passes and is emitted to the outside,
wherein the bezel comprises at least one bridge portion that is formed along a lateral direction of the opening so as to partially bridge opposed walls of the opening in the lateral direction.

(2) The light guide may comprise a plurality of light scattering portions formed along the longitudinal direction to cause the light guided in the longitudinal direction to be emitted in the emission direction, and wherein the light scattering portions may be positioned based on a position of the bridge portion.

(3) The light scattering portions may be arranged so as not to be located at a position in the longitudinal direction onto which the bridge portion is projected in a normal direction of the light guide.

(4) The light scattering portion may comprise a lens cut portion formed in a groove shape.

(5) The light emitted from the light guide may be emitted from the opening to the outside through an outer lens having a light diffusion effect.

(6) The light guide may be arranged in a width direction of the vehicle, and wherein the light emitted from the opening may be shone on an instrument panel.

### Advantageous Effects of Invention

According to the lighting device of the invention, it is possible to maintain the shape of an elongated-shaped opening.

### BRIEF DESCRIPTION OF DRAWINGS

FIG. 1 is a three-dimensional perspective view showing the interior of a vehicle as an example where a lighting device in an embodiment of the present invention is installed.

FIG. 2A is a three-dimensional perspective view showing the entire lighting device in the embodiment of the invention.

FIG. 2B is a cross-sectional view taken along line A-A in FIG. 2A.

FIG. 3 is a three-dimensional perspective view showing an entire bezel, which is a component of the lighting device.

FIG. 4 is an enlarged cross-sectional view taken along line B-B in FIG. 2A.

FIG. 5A is a diagram illustrating a positional relationship between a bridge portion formed at an opening of the bezel and lens cut portions of a light guide in the lighting device in the embodiment of the invention.

FIG. 5B is a diagram illustrating a positional relationship between the bridge portion formed at the opening of the bezel and the lens cut portions of the light guide in Comparative Example.

FIG. 6A is a diagram illustrating a state in which an upper instrument panel arranged above a lower instrument panel of the vehicle shown in FIG. 1 is illuminated by the lighting device in the embodiment of the invention.

FIG. 6B is a diagram illustrating a state in which the upper instrument panel arranged above the lower instrument panel of the vehicle shown in FIG. 1 is illuminated by the lighting device in Comparative Example.

### DESCRIPTION OF EMBODIMENTS

### Embodiment of the Invention

Alighting device 1 in the embodiment of the invention has a light source portion 10, a light guide 20, and a bezel 30. The light guide 20 is a light guide body with an elongated shape, guides light incident from the light source portion 10 in a longitudinal direction of the elongated shape, and emits the light in an emission direction substantially orthogonal to the longitudinal direction. The bezel 30 is provided along the light guide 20 and has an elongated-shaped opening 35 through which the light emitted from the light guide 20 passes and is emitted to the outside. The bezel 30 has at least one bridge portion 36 that is formed along the lateral direction of the opening 35 (which is herein defined as a direction perpendicular to the longitudinal direction of the opening 35) so as to partially bridge opposed walls of the opening 35 in the lateral direction.

Since the lighting device 1 in the embodiment of the invention is a device which emits light from the elongated-shaped opening 35 to the outside, the object to be illuminated with light may be various objects or design surfaces with designs, etc.

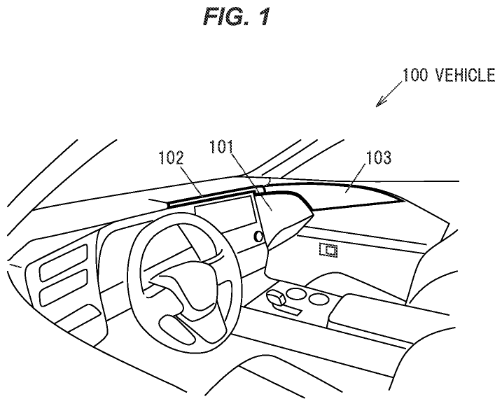

FIG. 1 is a three-dimensional perspective view showing the interior of a vehicle as an example where a lighting device in the embodiment of the invention is installed. An instrument panel has a lower instrument panel 101 and an upper instrument panel 102. In the embodiment of the invention, as an example, the lighting device 1 is mounted on a portion of the lower instrument panel 101 of a vehicle 100 as shown in FIG. 1. An example is described below where the lighting device 1 is installed in a vehicle cabin in which the upper instrument panel 102 and a door trim 103 are arranged above the lower instrument panel 101, and the lighting device 1 emits light to illuminate the upper instrument panel 102. That is, the light guide 20 is arranged in a width direction of the vehicle 100, and light emitted from the opening 35 is shone on the lower instrument panel 101.

(The Light Source Portion 10)

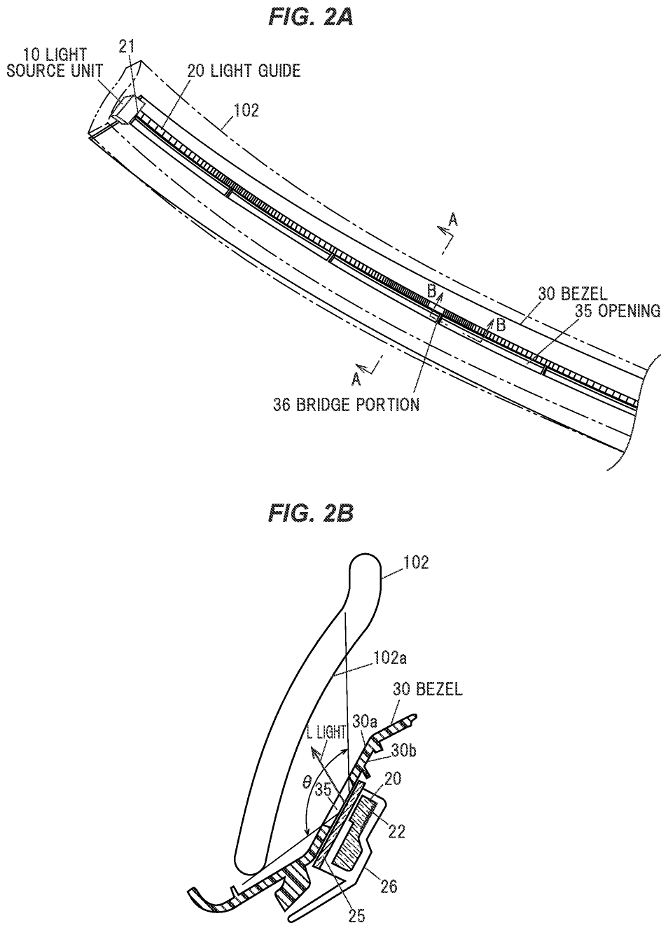

FIG. 2A is a three-dimensional perspective view showing the entire lighting device in the embodiment of the invention, and FIG. 2B is a cross-sectional view taken along line A-A in FIG. 2A. The light source portion 10 is to generate light to be injected into the light guide 20 from one end 21 of the light guide 20. The light source portion 10 used here is an LED (Light Emitting Diode) element as an example, but various light sources such as EL (Electro Luminescence) element or light bulb can be used. The light source portion 10, which is an LED element, mainly emits visible light and can emit white light, light of each color of R, G, and B, or light of any color as a mixture thereof. Thus, illumination light guided by the light guide 20 from the light source portion 10 and shone on an illuminated object, e.g., the upper instrument panel 102, can be set to various colors and arbitrary illuminance.

(The Light Guide 20)

As shown in FIG. 2A, the light guide 20 is a light guide body with an elongated shape formed of a translucent material to guide light from the light source portion 10 and emit the light to the outside. The light guide 20 can be formed of, e.g., a resin with high transparency, such as PC (Polycarbonate) or PMMA (Polymethylmethacrylate).

The light guide 20 is formed in an elongated shape, and plural light scattering portions to cause light guided in the longitudinal direction to be emitted in an emission direction substantially orthogonal to the longitudinal direction are formed along the longitudinal direction. The shape and position of lens cut portions 22 as the light scattering portions will be described later.

(The Bezel 30)

As shown in FIGS. 2A and 2B, the bezel 30 is a frame which is provided along the light guide 20 and has the elongated-shaped opening 35 through which light emitted from the light guide 20 passes and is emitted to the outside. The opening 35 is formed as a long through-hole having an elongated shape tailored to the elongated-shaped light guide 20. The bezel 30 can be formed of a synthetic resin such as ABS (Acrylonitrile Butadiene Styrene), as an example.

As shown in FIG. 2A, the bezel 30 is arranged between the light guide 20 and the upper instrument panel 102 as an object to be illuminated with light. An outer lens 25 having a light diffusion effect, the light guide 20, and a housing 26 are arranged in this order and attached to the bezel 30 on a back surface 30b side. A unit body integrally including the bezel 30 and these components is attached to the upper instrument panel 102 at a predetermined angle. A cover, etc., of the lower instrument panel 101 shown in FIG. 1 is omitted.

As shown in FIG. 2B, light L guided in the light guide 20 passes through the outer lens 25 and the opening 35, is emitted from a front surface 30a of the bezel 30 to the outside within a predetermined emission angle θ, and illuminates a design surface of the upper instrument panel 102.

The outer lens 25 is an optical element to evenly diffuse the light emitted from the light guide 20 to the outside. The outer lens 25 is, e.g., a transparent resin article molded into an elongated shape similar to the light guide 20 and textured to diffuse (scatter) light. Alternatively, the outer lens 25 is formed of a resin to which fine particles of silica, aluminum oxide or titanium oxide, etc. having high light diffusing (light scattering) properties are added as a light diffuser and which is molded into an elongated shape similar to the light guide 20.

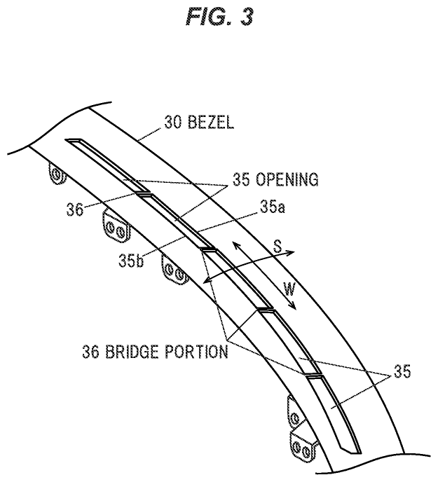

FIG. 3 is a three-dimensional perspective view showing the entire bezel 30, which is a component of the lighting device 1. As described above, the bezel 30 is formed as an elongated-shaped frame tailored to the elongated-shaped light guide 20. As shown in FIG. 3, the elongated-shaped opening 35 is formed in a longitudinal direction W of the elongated shape. The bezel 30 has at least one bridge portion 36 that is formed so as to bridge or connect opposed walls of the opening 35 in a lateral direction S of the opening 35. That is, the bridge portion 36 is formed as a reinforcing portion by which an opening edge 35a of the opening 35 along the longitudinal direction W and an opening edge 35b opposite thereto are bridged or connected in the lateral direction S. Thus, the opening 35 of the bezel 30 is reinforced by a bridging portion constructed by the bridge portion 36 that is formed so as to bridge or connect opposed walls of the opening 35 in the lateral direction S.

When, e.g., the bezel 30 is formed by molding a resin, the bridge portion 36 may be integrally molded at the same time as forming the opening 35 or may be added as a reinforcing member after the bezel 30 is formed. In the present embodiment, the bridge portions 36 are integrally molded at the same time as forming the opening 35 when the bezel 30 is formed by molding a resin, as shown in FIG. 3.

The bridge portion 36 serves as a reinforcing portion to provide the bridging in the lateral direction S of the opening 35 that is formed as a long through-hole having an elongated shape. The number of bridge portions 36 can be set according to the design so that the opening 35 formed as a long through-hole having an elongated shape has necessary and sufficient rigidity. In the present embodiment, four bridge portions 36 are provided in the longitudinal direction W of the opening 35 at equal intervals, as shown in FIG. 3. It is thereby possible to maintain the shape of the elongated-shaped opening 35 of the bezel 30.

(The Lens Cut Portion 22)

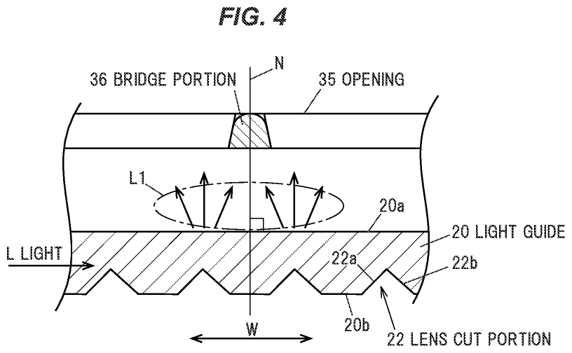

FIG. 4 is an enlarged cross-sectional view taken along line B-B in FIG. 2A. The light scattering portions are the lens cut portions 22 formed in a groove shape. As shown in FIG. 4, the lens cut portions 22 as the light scattering portions are substantially V-shaped recesses formed along the longitudinal direction W on a back surface 20b side of the light guide 20. An angle of V of this V-shape can be arbitrarily set in consideration of the direction and intensity of light scattering.

The light L being guided in the light guide 20 travels in the longitudinal direction W while being internally reflected in various directions in the light guide 20. The light L is reflected at inclined surfaces 22a and 22b of the substantially V-shaped lens cut portions 22, travels toward a front surface 20a of the light guide 20, and is emitted toward the opening 35. Light L1, which has a vector component of the normal line N orthogonal to the surface 20a at the surface 20a of the light guide 20, is emitted from the surface 20a of the light guide 20 to the outside.

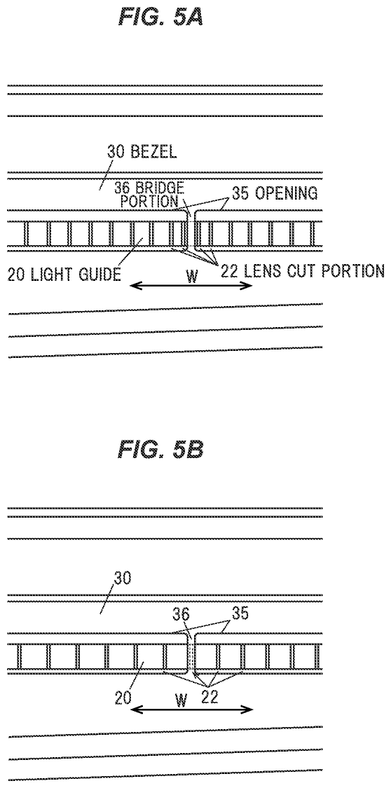

FIG. 5A is a diagram illustrating a positional relationship between the bridge portion formed at the opening of the bezel and the lens cut portions of the light guide in the lighting device in the embodiment of the invention, and FIG. 5B is a diagram illustrating a positional relationship between the bridge portion formed at the opening of the bezel and the lens cut portions of the light guide in Comparative Example.

FIG. 5A shows a positional relationship between the opening 35 and the bridge portions 36 of the bezel 30 and the lens cut portions 22 of the light guide 20 when viewed in a direction of the normal line N shown in FIG. 4. The lens cut portions 22 as the light scattering portions are positioned based on the positions of the bridge portions 36. The lens cut portions 22 are arranged so as not to be located at positions in the longitudinal direction W onto which the bridge portions 36 are projected in the normal direction of the light guide. That is, the bridge portions 36 are arranged so as not to overlap the lens cut portions 22 when viewed in the direction of the normal line N shown in FIG. 4. In other words, the bridge portions 36 are arranged so as not to overlap the lens cut portions 22 when the bridge portions 36 are projected on the light guide 20 in the direction of the normal line N shown in FIG. 4.

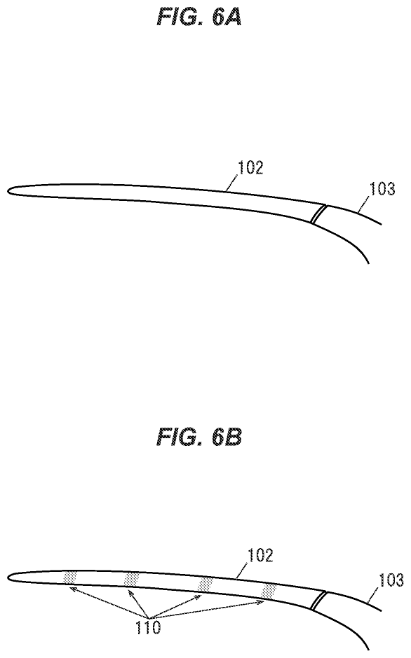

FIG. 6A is a diagram illustrating a state in which the upper instrument panel arranged above the lower instrument panel of the vehicle shown in FIG. 1 is illuminated by the lighting device in the embodiment of the invention, and FIG. 6B is a diagram illustrating a state in which the upper instrument panel arranged above the lower instrument panel of the vehicle shown in FIG. 1 is illuminated by the lighting device in Comparative Example.

When the positional relationship is as described above, i.e., when the bridge portions 36 are arranged so as not to overlap the lens cut portions 22 when viewed in the direction of the normal line N shown in FIG. 4, illumination of the upper instrument panel 102 is such that light emitted from the opening 35 of the bezel 30 and light passing through the bridge portions 36 and therearound are uniform in intensity of illumination, as shown in FIG. 6A. That is, the configuration in the present embodiment can provide the lighting device 1 with which unevenness of illumination cannot be visually perceived within the limit of human visual perception, or is not annoying.

### Comparative Example

FIG. 5B is a diagram illustrating a positional relationship between the bridge portion formed at the opening of the bezel and the lens cut portions of the light guide in Comparative Example. The lens cut portions 22 are arranged at positions in the longitudinal direction W onto which the bridge portions 36 are projected in the normal direction of the light guide. That is, the bridge portions 36 overlap the lens cut portions 22 when viewed in the direction of the normal line N shown in FIG. 4.

When the positional relationship is as described above, i.e., when the bridge portions 36 overlap the lens cut portions 22 when viewed in the direction of the normal line N shown in FIG. 4, illumination of the upper instrument panel 102 is such that light emitted from the opening 35 of the bezel 30 and light passing through the bridge portions 36 and therearound are not uniform in intensity of illumination, and shadows 110 due to the bridge portions 36 are visible, as shown in FIG. 6B. That is, in Comparative Example, unevenness of the illumination can be visually perceived within the limit of human visual perception, or annoying illumination unevenness occurs.

### Effects of the Embodiment of the Invention

(1) The lighting device 1 in the embodiment of the invention has the light source portion 10, the light guide 20 which is a light guide body with an elongated shape, guides light incident from the light source portion 10 in the longitudinal direction of the elongated shape, and emits the light in the emission direction substantially orthogonal to the longitudinal direction, and the bezel 30 which is provided along the light guide 20 and has an elongated-shaped opening 35 through which the light emitted from the light guide 20 passes and is emitted to the outside, and the bezel 30 has at least one bridge portion 36 that is formed so as to provide the bridging in the lateral direction of the opening 35. Since the lighting device 1 has a bridging structure having at least one bridge portion 36 that is provided at the elongated-shaped opening 35 to provide the bridging in the lateral direction of the opening 35, the rigidity of the elongated shape in the lateral direction is increased, which suppresses deflection and allows the elongated-shaped opening 35 to maintain its shape.

(2) The lens cut portions 22 as the light scattering portions are arranged so as not to be located at positions in the longitudinal direction W onto which the bridge portions 36 are projected in the normal direction of the light guide. As a result, illumination by the lighting device 1 is such that light emitted from the opening 35 of the bezel 30 and light passing through the bridge portions 36 and therearound are uniform in intensity of illumination. That is, the configuration in the present embodiment can provide the lighting device 1 with which unevenness of illumination cannot be visually perceived within the limit of human visual perception, or is not annoying.

(3) The light L guided in the light guide 20 passes through the outer lens 25 and the opening 35, is emitted from the front surface 30a of the bezel 30 to the outside within the predetermined emission angle θ, and illuminates the design surface. In the lighting device 1, the outer lens 25, which is textured or to which fine particles of silica, aluminum oxide or titanium oxide, etc. having high light diffusing (light scattering) properties are added as a light diffuser, is used as an optical element to evenly diffuse light emitted to the outside. This further reduces the unevenness of illumination described in the above (2).

Although the embodiment of the invention has been described, the invention is not intended to be limited to the embodiment, and the various kinds of modifications can be implemented without departing from the gist of the invention. In addition, the embodiment described above does not limit the invention according to the claims. Further, please note that not all combinations of the features described in the embodiment are necessary to solve the problem of the invention.

### REFERENCE SIGNS LIST

1 LIGHTING DEVICE
10 LIGHT SOURCE PORTION
20 LIGHT GUIDE
20a FRONT SURFACE
20b BACK SURFACE
21 ONE END
22 LENS CUT PORTION
22a, 22b INCLINED SURFACE
25 OUTER LENS
26 HOUSING
30 BEZEL
30a FRONT SURFACE
30b BACK SURFACE
35 OPENING
35a, 35b OPENING EDGE
36 BRIDGE PORTION
100 VEHICLE
101 LOWER INSTRUMENT PANEL
102 UPPER INSTRUMENT PANEL
103 DOOR TRIM
110 SHADOW
L, L1 LIGHT
N NORMAL LINE
S LATERAL DIRECTION
W LONGITUDINAL DIRECTION
θ EMISSION ANGLE

1. Alighting device, comprising:
a light source portion;
a light guide that comprises a light guide body with an elongated shape, guides light incident from the light source portion in a longitudinal direction of the elongated shape, and emits the light in an emission direction substantially orthogonal to the longitudinal direction; and
a bezel that is provided along the light guide and comprises an elongated-shaped opening through which the light emitted from the light guide passes and is emitted to the outside,
wherein the bezel comprises at least one bridge portion that is formed along a lateral direction of the opening so as to partially bridge opposed walls of the opening in the lateral direction.

2. The lighting device according to claim 1, wherein the light guide comprises a plurality of light scattering portions formed along the longitudinal direction to cause the light guided in the longitudinal direction to be emitted in the emission direction, and wherein the light scattering portions are positioned based on a position of the bridge portion.

3. The lighting device according to claim 2, wherein the light scattering portions are arranged so as not to be located at a position in the longitudinal direction onto which the bridge portion is projected in a normal direction of the light guide.

4. The lighting device according to claim 2, wherein the light scattering portion comprises a lens cut portion formed in a groove shape.

5. The lighting device according to claim 1, wherein the light emitted from the light guide is emitted from the opening to the outside through an outer lens having a light diffusion effect.

6. The lighting device according to claim 1, wherein the light guide is arranged in a width direction of the vehicle, and wherein the light emitted from the opening is shone on an instrument panel.
